(19) United States
(12) Patent Application Publication
(10) Pub. No.: US 2005/0224274 A1
(43) Pub. Date: Oct. 13, 2005

(54) Exhaust apparatus for engine

(76) Inventors: Kouji Shimoji, Okazaki-shi (JP); Takashi Ishikawa, Okazaki-shi (JP)

Correspondence Address: KENYON & KENYON, 1500 K STREET NW, SUITE 700, WASHINGTON, DC, 20005, US

(21) Appl. No.: 11/080,552

(22) Filed: Mar. 16, 2005

(30) Foreign Application Priority Data
Apr. 9, 2004 (JP) 2004-115976

(51) Int. Cl. B60K 13/04

(52) U.S. Cl. 180/309

(57) ABSTRACT

An exhaust apparatus for and engine is mounted on a vehicle, which includes an engine compartment, a passenger compartment, a dash panel, which separates the engine compartment and the passenger compartment from each other, a floor panel of the passenger compartment, and a seat, which includes a bottom arranged on the floor panel. A recess is formed in the lower surface of the floor panel located below the bottom. The exhaust apparatus includes an exhaust passage, which extends from the engine compartment to below the floor panel, a catalytic converter located in the exhaust passage, and a muffler located in the exhaust passage. The catalytic converter is located forward of the dash panel. The muffler is accommodated in the recess. It is preferable that the seat be located at the front portion of the vehicle, the recess be located below the seat, and the muffler be accommodated in the recess.

### BACKGROUND OF THE INVENTION

The present invention relates to an exhaust apparatus for an engine, which has a muffler below a passenger compartment.

Such an exhaust apparatus for an engine is required to be very quiet in addition to a demand for the basic performances such as the exhaust purifying performance and the engine output performance. To respond to such demands, the capacity of the muffler has been increased.

In a vehicle, in addition to improving the quietness, it is also important to increase the space in the passenger compartment such as a foot space. As measures to further increase the space in the passenger compartment, the floor of the passenger compartment may be flattened and lowered.

For example, Japanese Patent No. 2971341 discloses an exhaust apparatus in which mufflers each having a relatively small capacity are arranged below a floor panel. When such an exhaust apparatus is employed, the floor panel is prevented from bulging due to the mufflers arranged beneath the floor panel. Therefore, the passenger compartment floor can be flattened and lowered. This increases the space in the passenger compartment.

However, there is a limit in miniaturizing the mufflers when the basic performances as the muffler are taken into consideration. Thus, bulging of the floor panel due to arranging the mufflers is inevitable. Therefore, a configuration in which small mufflers are arranged at separate positions as in the above publication contributes to flattening and lowering of the passenger compartment floor only by a limited degree. In this respect, such configurations are susceptible to improvement.

### SUMMARY OF THE INVENTION

Accordingly, it is an objective of the present invention to provide an exhaust apparatus for an engine that effectively flattens and lowers a passenger compartment floor.

One embodiment of the present invention provides an exhaust apparatus for an engine mounted on a vehicle. The vehicle includes an engine compartment, a passenger compartment, a dash panel, which separates the engine compartment and the passenger compartment from each other, a floor panel of the passenger compartment, and a seat, which includes a bottom arranged on the floor panel. A recess is formed in the lower surface of the floor panel located below the bottom. The exhaust apparatus includes an exhaust passage, which extends from the engine compartment to below the floor panel, a catalytic converter located in the exhaust passage, and a muffler located in the exhaust passage. The catalytic converter is located forward of the dash panel. The muffler is accommodated in the recess.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic view illustrating a vehicle equipped with an exhaust apparatus of one embodiment, an engine of the vehicle, and parts of an exhaust system of the engine;

FIG. 2 is a partial cross-sectional view, with a part cut away, showing the catalytic converter;

FIG. 3A is a schematic cross-sectional plan view illustrating the catalyst;

FIG. 3B is a partially enlarged view of FIG. 3A;

FIG. 3C is a side view illustrating the catalyst;

FIG. 4 is a schematic view illustrating a modified exhaust apparatus;

FIG. 5 is a schematic view illustrating a modified exhaust apparatus;

FIG. 6 is a schematic view illustrating a modified exhaust apparatus; and

FIG. 7 is a schematic view illustrating a modified exhaust apparatus.

### DETAILED DESCRIPTION OF THE PREFERRED EMBODIMENTS

An exhaust apparatus 1 for an engine 3 according to one embodiment of the present invention will now be described with reference to the drawings.

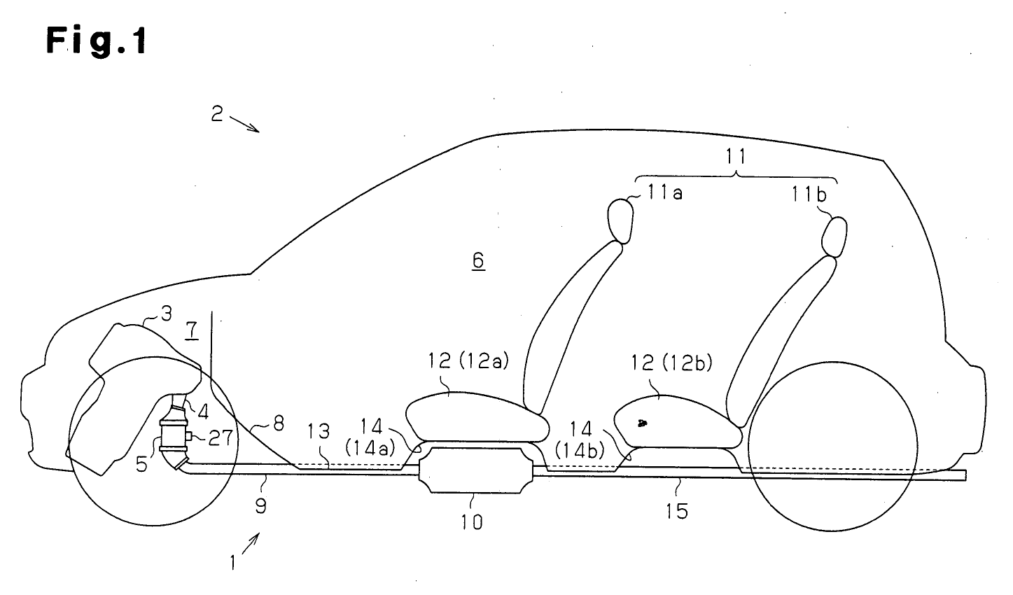

FIG. 1 shows a vehicle 2 equipped with the exhaust apparatus 1 of the preferred embodiment, the engine 3 of the vehicle 2, and parts of exhaust system of the engine 3. As shown in FIG. 1, the exhaust system of the engine 3 mounted on the vehicle 2 includes an exhaust manifold 4. In the exhaust apparatus 1 of the preferred embodiment, since the engine 3 employs a “rear exhaust type mounting system”, the exhaust manifold 4 is arranged at the rear of the engine 3. A catalytic converter 5, which purifies harmful components in combustion gas, is connected to the downstream section of the exhaust manifold 4.

In the preferred embodiment, the catalytic converter 5 is located forward of a passenger compartment 6 in the vehicle 2. More specifically, the catalytic converter 5 is located forward of a dash panel 8, which separates the passenger compartment 6 and the engine compartment 7 from each other, and is located directly below the exhaust manifold 4.

A muffler 10 is connected to the downstream section of the catalytic converter 5 via an exhaust pipe 9. The muffler 10 suppresses noise caused by fluctuation of the pressure of combustion gas by canceling the fluctuation of the pressure of combustion gas emitted from the engine 3.

Three seats 11 are arranged in the passenger compartment 6 of the preferred embodiment. The three seats 11 include two front seats 11a, which are for a driver and a front passenger to be seated-separately, and a rear seat 11b, which is for two or three passengers to be seated along a lateral direction. Accommodating recesses 14 (14a, 14b) are formed below bottoms 12 (12a, 12b) of the seats 11 by bulging the floor panel 13 toward the passenger compartment 6, that is, upward. The muffler 10 is accommodated in the accommodating recess 14a formed below the bottom 12a of one of the front seats 11a. That is, the muffler of the exhaust system of the vehicle 2 of the preferred embodiment corresponds to only the muffler 10 located below the bottom 12a of the front seat 11a, and no other muffler except the muffler 10 is provided in the vehicle 2.

In this exhaust system, combustion gas emitted from the engine 3 flows through the exhaust manifold 4, the catalytic converter 5, the exhaust pipe 9, and the muffler 10. After the combustion gas is purified in the catalytic converter 5, noise is suppressed in the muffler 10. Thereafter, the combustion gas is emitted outside the vehicle 2 from an exhaust pipe 15. That is, in the preferred embodiment, an exhaust passage is formed of the exhaust manifold 4 and the exhaust pipes 9, 15, which are located in a space extending from the engine compartment 7 to below the floor panel 13. The catalytic converter 5 and the muffler 10 are located in the exhaust passage.

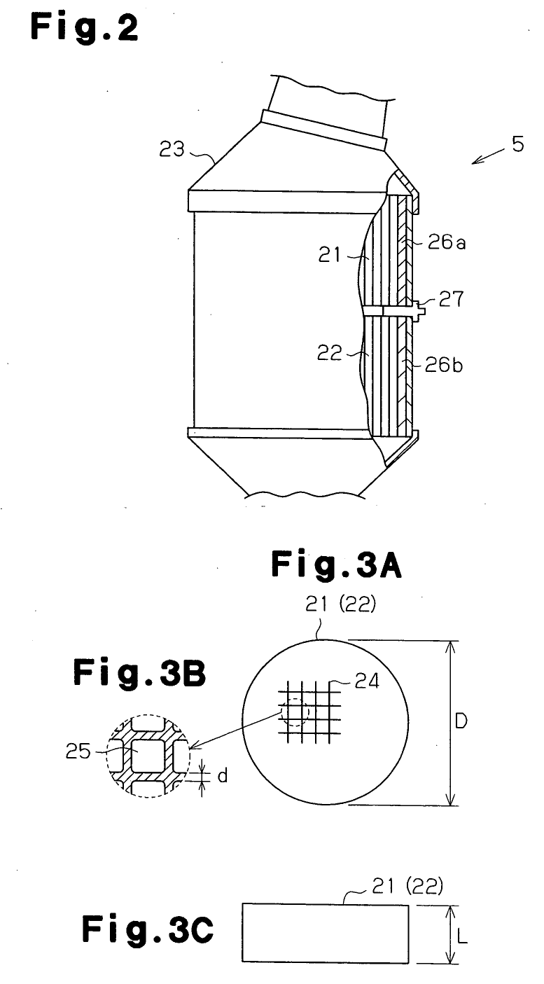

As shown in FIG. 2, the catalytic converter 5 of the preferred embodiment is an “integrated tandem type catalytic converter” in which a primary catalyst 21 and a secondary catalyst 22 are arranged in series in a case 23.

As shown in FIGS. 3A, 3B, and 3C, the primary catalyst 21 and the secondary catalyst 22 are monolithic catalysts each including a single honeycomb-type support body 24. The support bodies 24 include cells 25 in the primary catalyst 21 and the secondary catalyst 22. The primary catalyst 21 is an oxidation catalyst, and Pd based catalyst is adhered to the surface of the support body 24 of the primary catalyst 21. The secondary catalyst 22 is a three way catalyst and Pt (Pt—Rh) based catalyst is adhered to the surface of the support body 24 of the secondary catalyst 22. In the primary catalyst 21, the ratio (D/L) of the outer diameter D to the length L along a direction combustion gas is emitted is greater than or equal to 1 (D/L≧1). In the primary catalyst 21, the number n of cells 25 is 600-900 and the thickness d of each cell 25 is 2-3 mm. In the secondary catalyst 22, the ratio (D/L) is less than or equal to one (D/L≦1), the number n of cells 25 is less than or equal to 400, and the thickness d of each cell 25 is 2-4 mm. This specification is substantially the same as the conventional catalyst.

As shown in FIG. 2, protective sheets 26a, 26b are located between the primary catalyst 21 and the case 23 and between the secondary catalyst 22 and the case 23, respectively. The protective sheets 26a, 26b prevent leakage of combustion gas and protect the support bodies 24. In the preferred embodiment, the protective sheet 26a located between the primary catalyst 21 and the case 23 is formed of a sheet that is mainly composed of alumina and the protective sheet 26b located between the secondary catalyst 22 and the case 23 is made by a thermally expansive sheet that includes organic binder.

In the preferred embodiment, an oxygen sensor 27, which detects oxygen contained in combustion gas, is located between the primary catalyst 21 and the secondary catalyst 22. Detection signals from the oxygen sensor 27 are used in a feedback control such as an air-fuel ratio control.

The present embodiment has the following advantages.

(1) The muffler 10 is located in the accommodating recess 14a, which is formed below the bottom 12a of one of the seats 11a among the seats 11. That is, the muffler 10 is accommodated below one of the bottoms 12 that tends to be a dead space. Since the accommodating recess 14a need not be formed in the floor panel 13 except below the bottoms 12 of the seats 11, the passenger compartment floor can be flattened and lowered at location other than below the bottoms 12 of the seats 11. Accordingly, the space in the passenger compartment 6 is increased. In this case, for example, a front floor tunnel may be omitted and the floor between the two front seats 11a may be flattened so that passengers can move between the front seats 11a and the rear seat 11b. Alternatively, the floor around the foot space may be lowered so that various types of layouts of the passenger compartment are easily achieved such as layouts for improving riding comfort and access to the vehicle.

(2) The muffler 10 is located below the bottom 12a of only one of the front seats 11a. Accordingly, the shape of the passenger compartment floor below the rear seat 11b can be varied. Therefore, for example, a structure other than the muffler 10 such as a fuel tank may be located below the rear seat 11b. This enlarges the trunk. Alternatively, the passenger compartment floor below the rear seat 11b may be leveled with the trunk floor, and the bottom 12b of the rear seat 11b may be pivotally attached to the floor panel 13 so that the bottom 12b can be flipped up. This permits the trunk to be expandable. Therefore, various layouts of the passenger compartment are possible.

(3) The catalytic converter 5 is located forward of the passenger compartment 6. More specifically, the catalytic converter 5 is located forward of the dash panel 8, which separates the passenger compartment 6 and the engine compartment 7 from each other. Since a space for accommodating the catalytic converter 5 need not be formed below the floor panel 13, the passenger compartment floor is allowed to be easily flattened and lowered.

(4) The catalytic converter 5 is provided with the primary catalyst 21, which includes the Pd based catalyst, and the secondary catalyst 22, which includes the Pt (Pt—Rh) based catalyst. Therefore, the warming performance and the durability when the engine 3 is cold are well balanced. That is, since the Pd based catalyst is used for the primary catalyst 21, the warming performance when the engine 3 is cold is improved. On the other hand, since the Pt based catalyst is used for the secondary catalyst 22, the durability of the catalytic converter 5 is improved. As a result, the combustion gas purifying performance when the engine 3 is cold is generally improved.

(5) The primary catalyst 21 and the secondary catalyst 22 are both monolithic catalysts each including a single honeycomb-type support body 24. Furthermore, the number n of cells 25 in the primary catalyst 21 is 600-900 and the thickness d of each cell 25 in the primary catalyst 21 is 2-3 mm.

In the conventional catalyst, the number of cells is less than or equal to 400 and the thickness of each cell is 2-4 mm. Therefore, according to the catalytic converter 5 of the preferred embodiment, the thickness d of each cell 25 in the primary catalyst 21 is formed thinner than that of the conventional catalyst. This suppresses increase of the back pressure at the upstream section of the catalyst due to pulsation flow of combustion gas. Furthermore, since the specific surface areas of the support bodies 24 are increased, the heat capacity of the converter 5 is reduced. This improves the warming performance of the converter 5 when the engine 3 is cold. Furthermore, since the cells 25 are easily formed to have a high density, the purifying performance is improved while preventing the catalytic converter 5 from being enlarged. Furthermore, the amount of precious metals such as palladium, platinum, and rhodium used in the catalytic converter 5 is decreased.

(6) The ratio (D/L) of the outer diameter D to the length L of the primary catalyst 21 is greater than or equal to 1 (D/L≧1). This sufficiently secures the capacity of the primary catalyst 21 and suppresses the increase of the back pressure at the upstream section of the catalyst due to the pulsation flow of combustion gas. As a result, the purifying performance and the durability of the catalytic converter 5 is improved without decreasing the output power of the engine 3.

(7) The protective sheet 26a located between the primary catalyst 21 and the case 23 is formed of a sheet that is mainly composed of alumina, and the protective sheet 26b located between the secondary catalyst 22 and the case 23 is made by a thermally expansive sheet that includes organic binder. In this case, since the organic binder is located downstream of the oxygen sensor 27, the oxygen sensor 27 is prevented from erroneously detecting components of the organic binder as oxygen in the combustion gas. Misoperation of the oxygen sensor 27 is therefore prevented. Furthermore, the cost of the catalytic converter 5 is reduced and the durability of the catalytic converter 5 is improved.

It should be apparent to those skilled in the art that the present invention may be embodied in many other specific forms without departing from the spirit or scope of the invention. Particularly, it should be understood that the invention may be embodied in the following forms.

The preferred embodiment may be modified as follows.

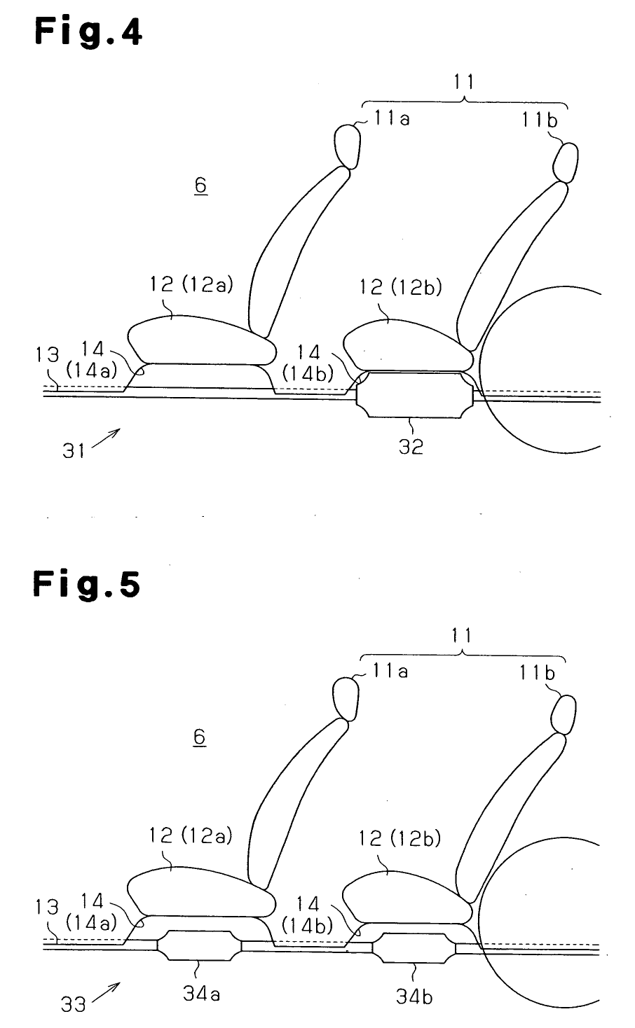

As shown in FIG. 4, a muffler 32 of an exhaust apparatus 31 may be located only below the bottom 12b of the rear seat 11b. As shown in FIG. 5, a muffler 34a may be located below the bottom 12a of one of the front seats 11a and a muffler 34b may be located below the bottom 12b of the rear seat 11. Several mufflers may be located below each seat 11.

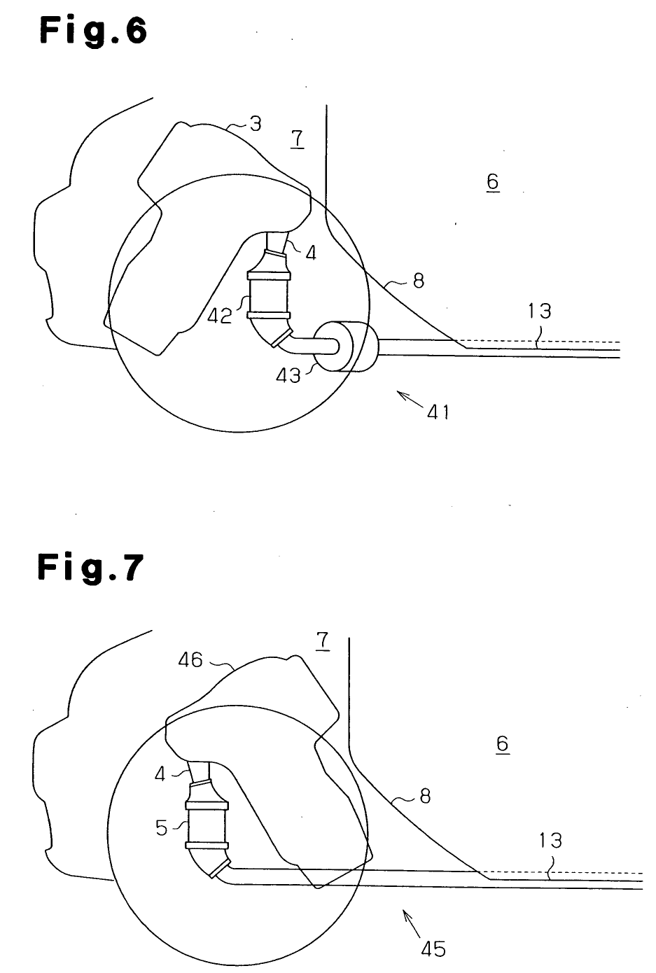

As shown in FIG. 6, a catalytic converter of an exhaust apparatus 41 may be formed of a first catalytic converter 42, which accommodates the primary catalyst 21, and a second catalytic converter 43, which accommodates the secondary catalyst 22. In this case, the first catalytic converter 42 and the second catalytic converter 43 are located forward of the passenger compartment 6 (forward of the dash panel 8) in the vehicle 2.

As shown in FIG. 1, the exhaust apparatus 1 of the preferred embodiment is embodied in the engine 3, which employs the rear exhaust type mounting system. However, as shown in FIG. 7, the structure of the preferred embodiment may be applied to an exhaust apparatus 45 of an engine 46, which employs a front exhaust type mounting system.

The preferred embodiment employs a two row seating configuration, in which the rear seat 11b is located behind the front seats 11a. However, several rows of seats may be located behind the front seats 11a as in a three row seating configuration, in which two rows of rear seats are provided.

In the preferred embodiment, by passing through the primary catalyst 21, the temperature of combustion gas is decreased and a laminar flow occurs. This eases the environment of the secondary catalyst 22. Therefore, the secondary catalyst 22 is designed to have substantially the same specification as the conventional catalyst. That is, the ratio D/L is less than or equal to one, the number n of cells 25 is less than or equal to 400, and the thickness d of each cell 25 is 2-4 mm. However, the specification of the secondary catalyst 22 may be changed in accordance with, for example, the output performance of the engine 3.

The protective sheet 26a located between the primary catalyst 21 and the case 23 may be formed of an alumina-silica based sheet and the protective sheet 26b located between the secondary catalyst 22 and the case 23 may be formed of a complex sheet in which alumina based sheet and a thermally expansive sheet are laminated.

Therefore, the present examples and embodiments are to be considered as illustrative and not restrictive and the invention is not to be limited to the details given herein, but may be modified within the scope and equivalence of the appended claims.

1. An exhaust apparatus for an engine mounted on a vehicle,
wherein the vehicle includes an engine compartment, a passenger compartment, a dash panel, which separates the engine compartment and the passenger compartment from each other, a floor panel of the passenger compartment, and a seat, which includes a bottom arranged on the floor panel, wherein a recess is formed in the lower surface of the floor panel located below the seat bottom, the exhaust apparatus comprising:
an exhaust passage, which extends from the engine compartment to below the floor panel;
a catalytic converter located in the exhaust passage, the catalytic converter being located forward of the dash panel; and
a muffler located in the exhaust passage, the muffler being accommodated in the recess.

2. The exhaust apparatus according to claim 1, wherein the seat is arranged at the front portion of the vehicle, the recess is located below the seat, and the muffler is accommodated in the recess.

3. The exhaust apparatus according to claim 1, wherein the catalytic converter includes a primary catalyst, which includes a Pd based catalyst, and a secondary catalyst, which includes a Pt (Pt—Rh) based catalyst, the primary catalyst being located upstream of the secondary catalyst.

4. The exhaust apparatus according to claim 3, wherein the primary catalyst and the secondary catalyst are both monolithic catalysts each including a single honeycomb-type support body, each support body has a plurality of cells, wherein the number of cells in the primary catalyst is 600-900, and the thickness of each cell in the primary catalyst is 2-3 mm.

5. The exhaust apparatus according to claim 3, wherein the ratio of the outer diameter to the length of the primary catalyst is greater than or equal to one.

6. The exhaust apparatus according to claim 3, wherein the catalytic converter includes a case, which accommodates the primary catalyst and the secondary catalyst, a sheet containing alumina is located between the primary catalyst and the case, and a thermally expansive sheet containing organic binder is located between the secondary catalyst and the case.
